(19) United States
(12) Patent Application Publication
(10) Pub. No.: US 2005/0138373 A1
(43) Pub. Date: Jun. 23, 2005

(54) Simplified computing interface

(76) Inventors: David R. Clark, Littleton, MA (US); Gary A. Clark, The Colony, TX (US)

Correspondence Address: Stephen R. Loe;The Law Office of Stephen R. Loe, P.O. Box 649, Frisco, TX, 75034, US

(21) Appl. No.: 10/738,245

(22) Filed: Dec. 17, 2003

(51) Int. Cl. G06F 12/14

(52) U.S. Cl. 713/166; 713/200

(57) ABSTRACT

A customized graphical user interface and method, system, and computer program product for providing the graphical user interface and for automating computer maintenance, security, and communication functions is provided. In one embodiment, the data processing system receives user login information and retrieves a user profile. Based on the user profile, a customized user interface is presented to the user. Only applications and information needed by the user to perform an enterprise defined function are presented to the user in the user interface, thereby eliminating the need for human input in these automated areas, thereby freeing an inexperienced user from wasting time trying to find applications and data needed to perform the user's work function. Furthermore, computer maintenance, communications, and security functions are performed with minimal user interaction, if any, further increasing the efficiency of the user in performing work functions and decreasing the training requirements for the user.

### BACKGROUND OF THE INVENTION

1. Technical Field

The present invention relates generally to computer software and, more particularly, to simplified computer interface and management system.

2. Description of Related Art

Mobile computing has the most potential to make an impact for plant floor and field workers when it is adapted into processes that have been largely manual and paper intensive. A significant majority of these workers are not familiar with the operation of hand held computers or even standard computers. The standard interface, provided with the operating system, tends to spread user applications across the device making it difficult for users to find the right applications to perform their job. Individual applications tend to exit to the operating system, potentially leaving the user wondering where they are and how to find their applications on the device. Inexperience users require a simplified consistent interface that provides a standard “launch point” for all applications used to perform their job.

An additional problem for the enterprise is the overall management of these devices while in the field. Since these devices have become a critical resource for the users, they cannot afford for these “tools” to be out of service for extended periods of time that may be required to update software, inventory the device contents, or add new applications. In common scenarios these devices may need to be attached to a computer via a cable connection to update information on the device. In other scenarios, some of this information can be managed over the wireless interface but this requires user intervention to launch certain applications from their device.

Finally, the use of hand held computers over wireless networks can create a security vulnerability that exposes the enterprise to loss of sensitive information or malicious attacks. These vulnerabilities could potentially occur if a malicious user where to gain access to the device and were able to extract stored information or access the enterprise network through connections established by the device. Securing this scenario requires the user to authenticate to the device with a unique id and pin number or password combination. An additional safeguard associated with this scenario is to encrypt all sensitive data on the device so that it is useless if extracted in some way other than entering the correct credentials to the device. If the incorrect credentials are enter more than a predetermined number of times, all sensitive data on the device is deleted. Another potential for loss of information is the interception of information on the wireless network. This information could be sensitive in nature or provide information to a competitor. This information may also provide credentials or other information that may provide access to the enterprise systems. To safeguard against this scenario, data traveling between the device and its applications must be encrypted to secure it against eavesdropping. Both of these policy requirements must be enforced on the device in a way that an inexperienced user can be ensured to successfully comply.

Therefore, it would be desirable to have a mobile computing interface designed to simplify multiple application usage for inexperienced users, create a remote management interface to the device that requires minimal or no user intervention, provides centralized application launching, remote device management and enterprise security enforcement for device usage in a wired or wireless network environment, in a manner that ensures user compliance.

### SUMMARY OF THE INVENTION

The present invention provides a customized graphical user interface and method, system, and computer program product for providing the graphical user interface and for automating computer maintenance, security, and communication functions. In one embodiment, the data processing system receives user login information and retrieves a user profile. Based on the user profile, a customized user interface is presented to the user. Only applications and information needed by the user to perform an enterprise defined function are presented to the user in the user interface, thereby eliminating the need for human input in these automated areas, thereby freeing an inexperienced user from wasting time trying to find applications and data needed to perform the user's work function. Furthermore, computer maintenance, communications, and security functions are performed with minimal user interaction, if any, further increasing the efficiency of the user in performing work functions and decreasing the training requirements for the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a block diagram of a personal digital assistant (PDA) in which the present invention may be implemented;

FIG. 5 depicts a pictorial diagram of an exemplary prior art user interface;

FIGS. 6A and 6B depicts pictorial representations of an exemplary simplified graphical user interface in accordance with one embodiment of the present invention;

FIG. 7 depicts a block diagram of an exemplary application for providing a simplified GUI and performing automatic computer maintenance, communications, and security functions in accordance with one embodiment of the present invention; and

FIG. 8 depicts a diagram illustrating an exemplary program function and process flow for providing a customized GUI and automatic computer maintenance functions in accordance with one embodiment of the present invention.

### DETAILED DESCRIPTION OF THE PREFERRED EMBODIMENT

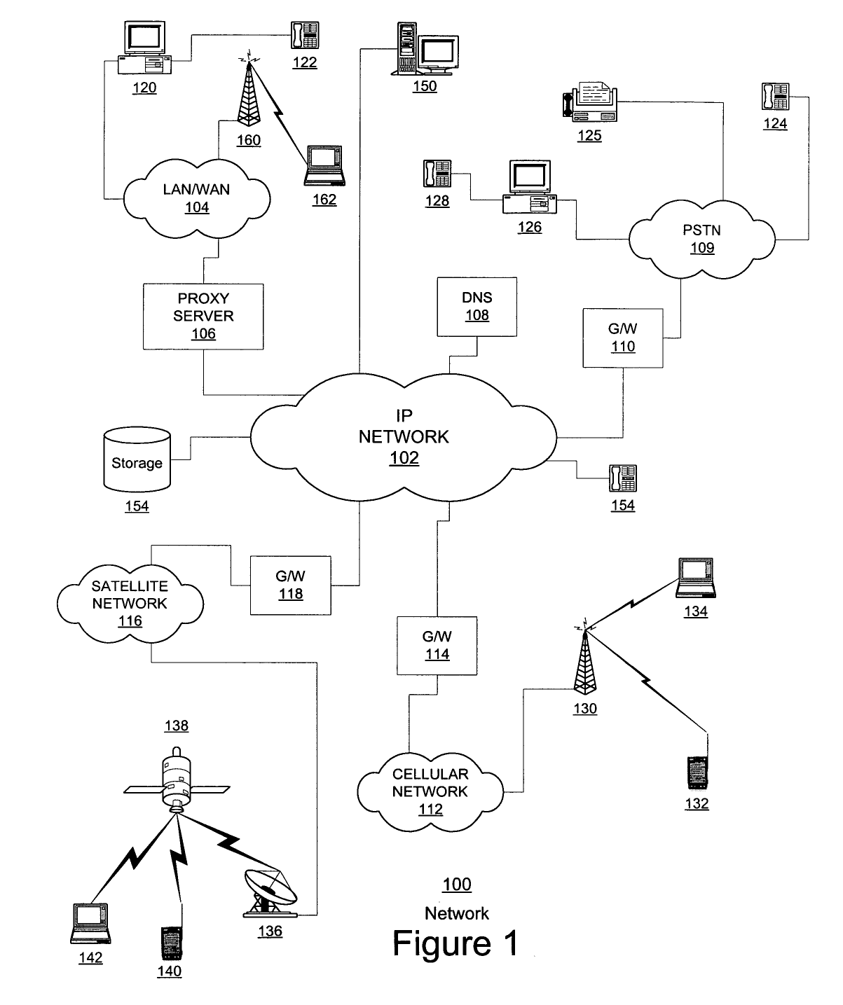

With reference now to the figures, and in particular with reference to FIG. 1, a system diagram illustrating a distributed data processing system in which a the present invention may be implemented is depicted.

Distributed data processing system 100 is a plurality of interconnected heterogeneous networks in which the present invention may be implemented. As illustrated, distributed data processing system 100 contains an Internet Protocol (IP) network 102, a Local Area Network (LAN)/Wide Area Network (WAN) 104, the Public Switched Telephone Network (PSTN) 109, a cellular wireless network 112, and a satellite communication network 116. Networks 102, 104, 109, 112, and 116 may include permanent connections, such as wire or fiber optic cables, or temporary connections made through telephone connections.

IP network 102 may be the publicly available IP network (the Internet), a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. A wirelessly enabled laptop 162 may also couple to LAN/WAN 104 via a wireless access point 160.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 through device-resident software applications (thick clients) or browser-based applications (thin client) such as wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. Both thin and thick clients are highly focused on the limited display size and limited input devices available on small, handheld devices. For example, a typical cell phone may have only a 4×10-character display with 16-gray levels and only a numeric keypad plus up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

In the depicted example, server 150 is connected to IP network 102, along with storage unit 154. In the depicted example, server 150 provides data, such as boot files, operating system images and applications, to clients 120, 126, 132, 134, 140, and 142. Server 150 may also push updates and collect data from clients 120, 126, 132, 134, 140, and 142. Storage unit 154 may provide a central repository for data and/or applications for an enterprise.

Enterprise employees in the field, for example, sales representatives or distributors, may utilize a portable data processing device, such as, for example, laptops 134 and 142 and Personal Digital Assistants (PDAs) 132 and 140 to support their job activities. Enterprise employees may also utilize wired data processing systems, such as, for example, data processing systems 120 and 126. The user interface on these enterprise data processing systems is customized to the user. If a data processing system may be used by several different users, a different user interface may be provided for each user depending on their job description and needs. The user interface provides a customized view of only the applications, data, messages, and other content necessary for the user to perform his or her job. Security issues, data transfer, application updates, establishing communication links, and other services critical or important to proper data processing system function or to enterprise function are performed automatically by the data processing system with little or no input or interaction with the user. Thus, the user is free to concentrate on job performance without concern for ancillary issues associated with proper computer function that may even be beyond the scope of expertise of the user.

FIG. 1 is intended as an example and not as an architectural limitation for the processes of the present invention. For example, distributed data processing system 100 may include additional servers, clients, and other devices not shown. Furthermore, in some embodiments, the functions performed by server 150 may be spread among several servers or there may be several redundant servers providing the same functionality in case one server fails.

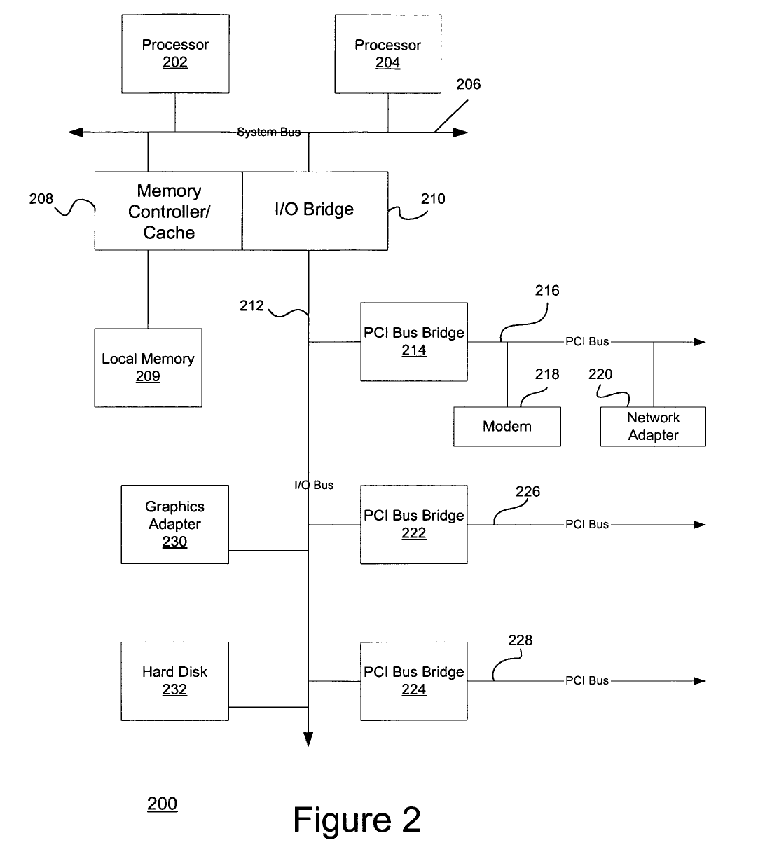

Referring to FIG. 2, a block diagram of a data processing system which may be implemented as a server, such as server 150 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 152 and 156 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Data processing system 200 communicates with data processing systems within the enterprise, such as, for example, any of computers 120 and 126, laptop computers 134 and 142, and PDAs 132 and 140. Data processing system 200 may route E-mail and other messages to appropriate data processing systems. Furthermore, data processing system 200 may push application updates and critical data to computers as well as pull data from the computers. Thus, enterprise employees in the field do not have to worry with establishing secure communication links with the central enterprise computer nor do they have to initiate data transfers or application updates. All these functions are provided for them to allow them to concentrate on their job duties and interact with their data processing system only as necessary to perform their critical job functions.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system or as an Intel based machine running a Windows NT® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries. Windows NT® Operating System is a product of the Microsoft Corporation of Redmond, Wash. Windows NT® is a registered trademark of the Microsoft Corporation.

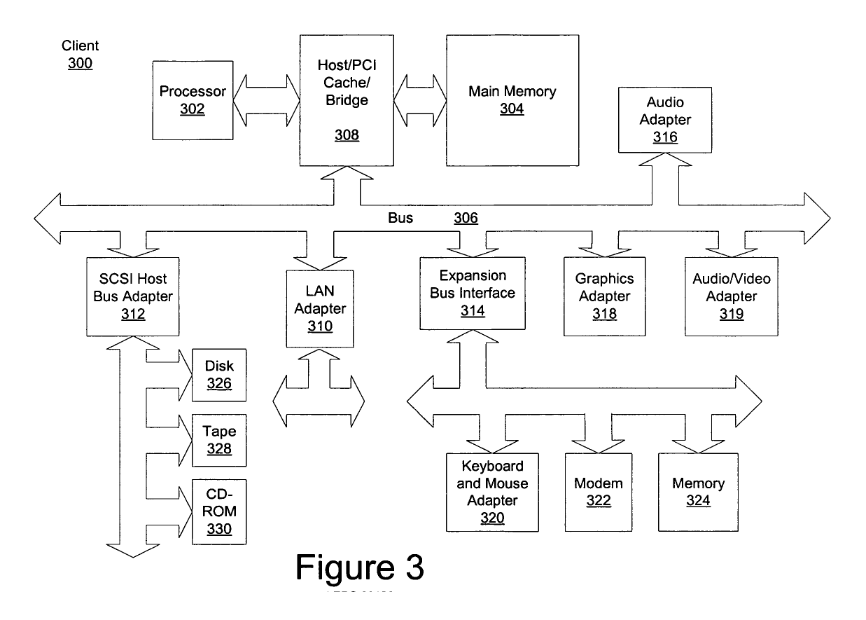

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP®, which is available from the Microsoft Corporation. “Windows XP® is a registered trademark of the Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Data processing system 300 also includes a simplified user interface that is typically customized for the user and runs on top of the operating system. This simplified user interface provides the user with access to only those applications and data that are critical to the performance of the user's job. This frees the user from having to search through the interface to find the particular application or data that the user needs since most user interfaces provide access to all applications and data within the data processing system. These prior art user interfaces are generalized to provide access to essentially everything within the data processing system because they are not customized to a specific user but rather are designed so that anyone using the computer can find and use what that user needs. However, in a business enterprise, many people require the use of computers in order to perform their specific job functions who are not familiar with or comfortable with computer use. Supplying them with a generalized interface may slow down performance of their job since they must waste time locating the items they need for their work. The simplified customized user interface provides these users with an interface that presents only the data, applications, and other functions that are necessary for their job performance. Other functions, such as establishing communication links with a central server or database, transferring data, and updating software are performed automatically for them by the data processing system 300. Simplified customized user interfaces according to the present invention are described in more detail below.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

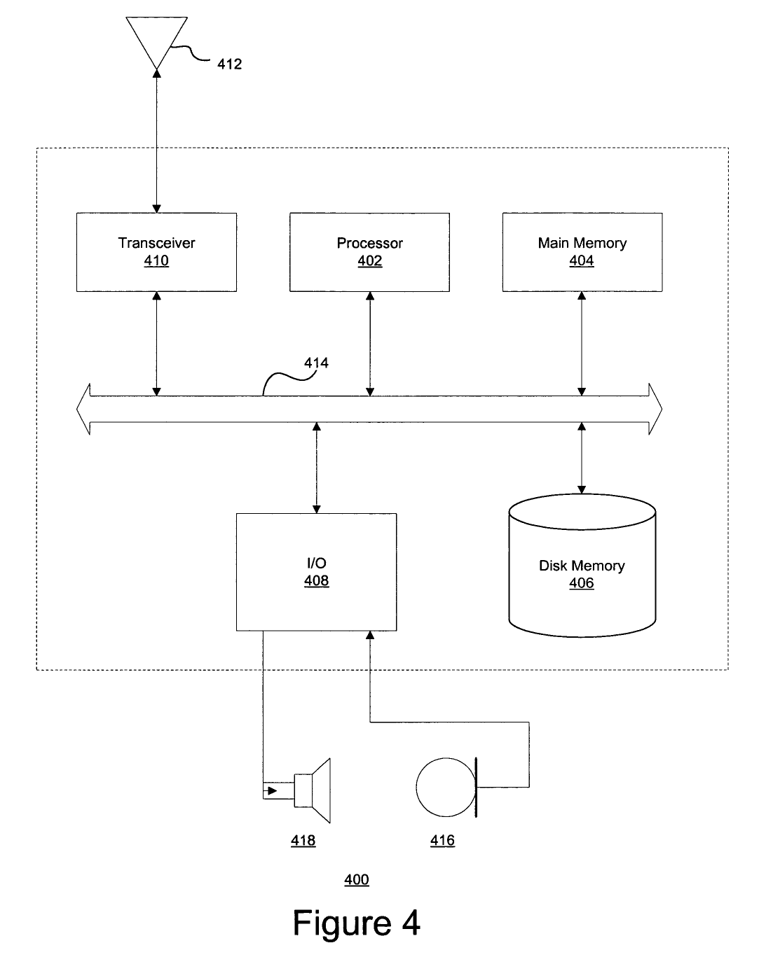

Turning now to FIG. 4, a block diagram of a personal digital assistant (PDA) is illustrated in which the present invention may be implemented. PDA 400 may be implemented as, for example, A PDA is a data processing system (i.e., a computer) which is small and portable. The PDA is typically a palmtop computer, such as, for example, a Palm Treo 600®, a product and registered trademark of 3Com Corporation in Santa Clara, Calif., which may be connected to a wireless communications network and which may provide voice, fax, e-mail, and/or other types of communication. An operating system, such as, for example, Pocket PC Windows Mobile®, also runs on PDA 400. Pocket PC Windows Mobile® is a product and registered trademark of the Microsoft Corporation. The PDA 400 may provide other types of facilities to the user as well, such as, for example, provide a calendar and day planner. The PDA 400 may have one or more processors 402, such as a microprocessor, a main memory 404, a disk memory 406, and an I/O 408 such as a mouse, keyboard, or pen-type input, and a screen or monitor. The PDA 400 may also have a wireless transceiver 410 connected to an antenna 412 configured to transmit and receive wireless communications. The processor 402, memories 404, 406, I/O 408, and transceiver are connected to a bus 404. The bus transfers data, i.e., instructions and information, between each of the devices connected to it. The I/O 408 may permit faxes, e-mail, or optical images to be displayed on a monitor or printed out by a printer. The I/O 408 may be connected to a microphone 416 and a speaker 418 so that voice or sound information may be sent and received.

However all of the functionality needed by a particular user is contained and provided by a simplified user interface as described below. This simplified computer interface provides all of the software applications, input fields, and other information necessary for the user to perform his function as well as performs tasks, such as updating software and communicating with a central server, such as, for example, server 150 in FIG. 1, that are invisible to the user and require little or no user interaction. Thus, the user is able to concentrate his entire attention on his work duties without worrying about how to start an application, update the software, or transmit or receive information from corporate headquarters.

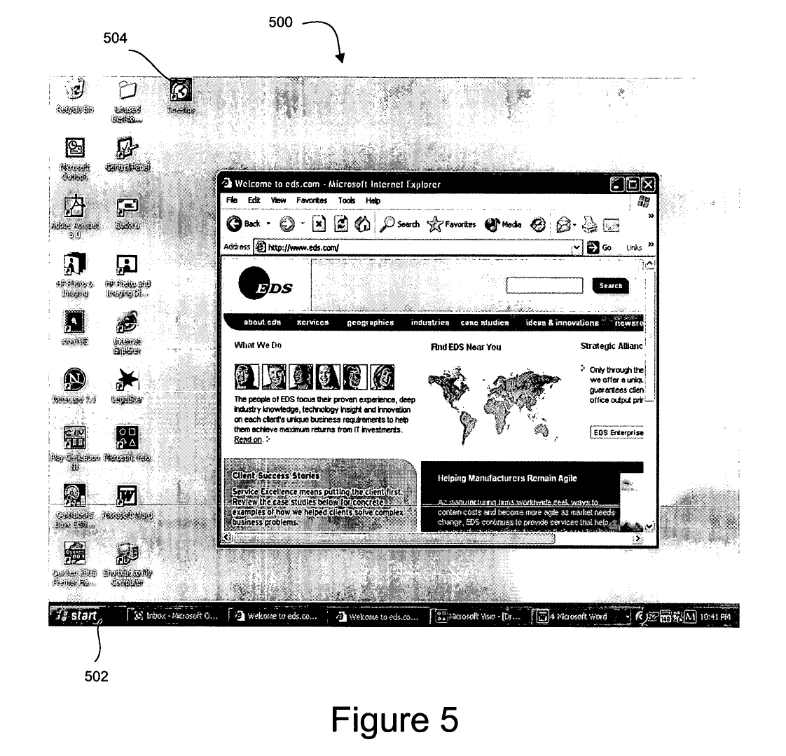

With reference now to FIG. 5, a pictorial diagram of an exemplary prior art user interface is depicted. User interface 500 provides users with a plurality of icons 504 which may be selected by a user to launch associated applications. Many of the icons represent applications that may not be utilized by some users. Furthermore, if an icon representing an application is not displayed, the user must select the “start” button 502 to browse for the desired application. If the user desires access to data or if maintenance needs to be performed, the user must have an even greater familiarity with computers in order to operate the computer properly. Furthermore, because so many options are available to the user, a greater deal of time is expended in finding and selecting the appropriate software application or data.

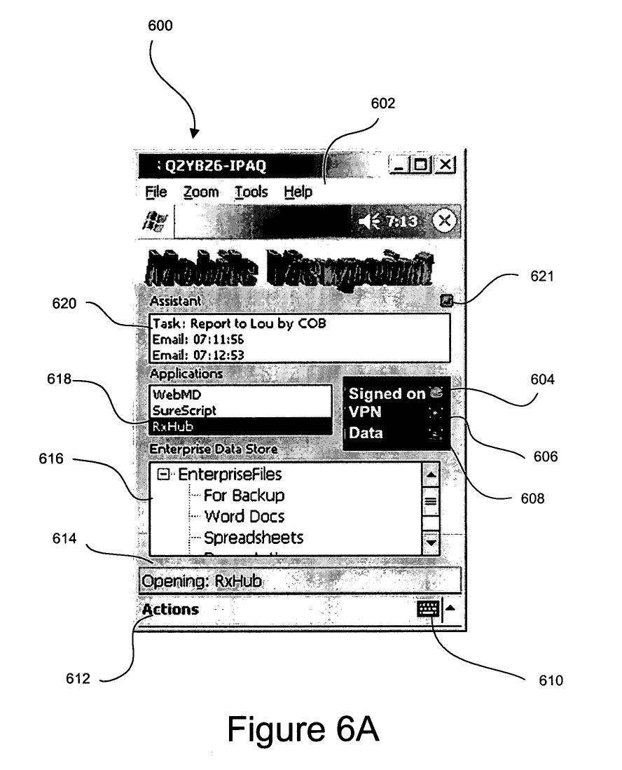

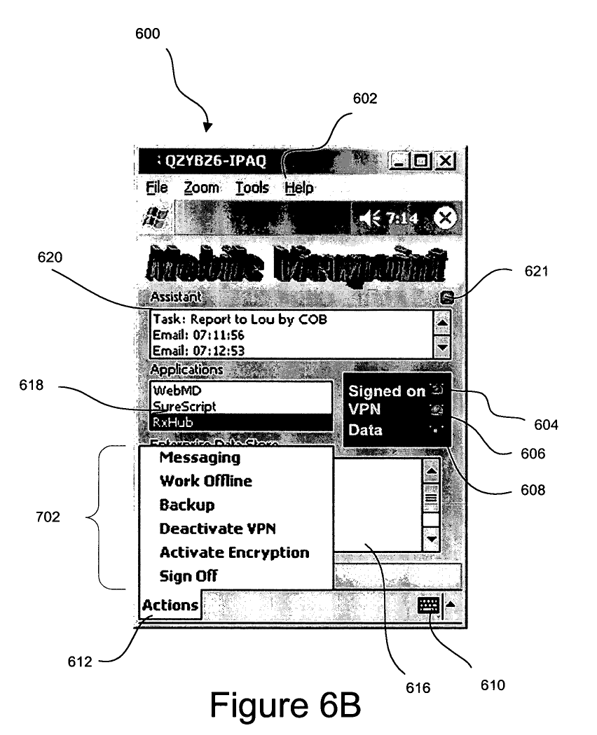

With reference now to FIG. 6A, a pictorial representation of an exemplary simplified graphical user interface is depicted in accordance with one embodiment of the present invention. Graphical user interface (GUI) 600 is much simplified over that of prior art user interfaces, such as the one depicted in FIG. 5. GUI 600 may be implemented on any data processing system such as, for example, either of data processing system 300 depicted in FIG. 3 or PDA 400 depicted in FIG. 4, or other data processing systems, such as, for example, tablet or lap-top computers.

GUI 600 is arranged to present the user with an application window 618 which contains a list of only the applications needed by the user to which the GUI 600 is tailored. The GUI 600 also includes an assistant window 620 which provides a list of e-mails and other communications and notices that are of importance to the user. The assistant window 620 may also provide the user with alerts from a server. These alerts maybe directed specifically to an individual, a group of individuals (by job code or other designation), or all users of the applications within network coverage. The alerts may relate to anything an enterprise determines is important for employees in the field to know. Each entry within both window 618 and window 620 are selectable to allow the user to either read the message or launch an application associated with the entry.

GUI 600 also includes an indication 604 of whether the user is signed on, an indication 606 of whether the user is logged into a virtual private network (VPN), and an indication 608 as to whether data is being transmitted to or from the computer. The indications 604-608 could be through the use of colored “lights” where, for example, green indicates that the user is signed on for indicator 604, the VPN is active for indicator 606, or data is being transmitted for indicator 608, and red would indicate the opposite status. Colored light 621 indicates the status of the wireless connection, for example, green indicates a connection is active while a red condition indicates not active connection.

GUI 600 includes an enterprise data store window 616 which provides the user with a list of and access to the data important for the performance of the user's work functions. A status bar 614 may also be provided that indicates what action is being performed by the data processing system. A tool bar 602 providing access to various tools that may be required by the user is presented in GUI 600. A keyboard icon 610 is provided that, if selected by the user, presents a user interactive graphic of a keyboard to allow a user to input data using a keyboard. Such a function is more important on physically smaller data processing systems in which a physical keyboard is not provided such as, for example, PDA 400 depicted in FIG. 4. GUI 600 also provides an “Actions” button 612 which, when selected, provides a pulldown list 702 of actions that the user may take as depicted in FIG. 6B.

GUI 600 is merely an example of a customized simplified GUI and is not meant as an architectural limitation of the present invention. Those skilled in the art will recognize that the types of and arrangement of windows, the applications provided, and other details will vary depending on the particular implementation and customization of the GUI 600. The list of features provided may vary and include fewer, more, or different features depending upon implementation.

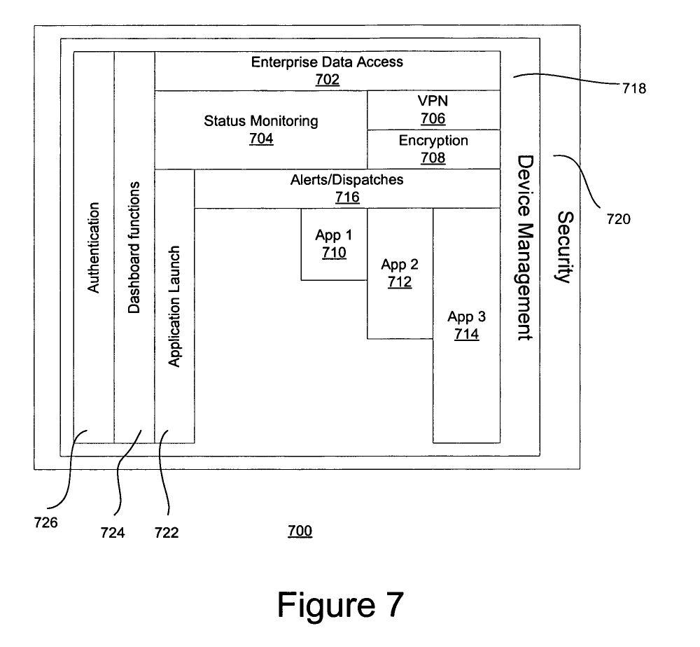

With reference now to FIG. 7, a block diagram of an exemplary application for providing a simplified GUI and performing automatic computer maintenance, communications, and security functions is depicted in accordance with one embodiment of the present invention. Application 700 may be implemented on a data processing system, such as, for example, data processing system 300 in FIG. 3 or PDA 400 in FIG. 4, and provides a customized GUI, such as, for example, GUI 600 depicted in FIG. 6A, to a user. Application 700 includes an authentication unit 726 which authenticates the identity of the user. Dashboard functions unit 724 provides the graphical user interface, such as GUI 600 in FIG. 6A, and functions associated with the GUI. Application launch 722 launches the various applications 710-714 presented to the user on the GUI when selected by the user. Application launch 722 also launches alerts/dispatches 716 as necessary alerting the user to any information for which the user should be made aware. Application 700 provides a status monitoring unit 704 that monitors the status of the data processing system.

VPN unit 706 implements a Virtual Private Network (VPN) connection. A VPN is an encrypted tunnel over an IP network. Encryption unit 708 provides encryption for communications between the data processing system and another data processing system, thereby protecting a business enterprises secrets and data. Encryption unit 708 is also responsible for encrypting data on the local data processing system to prevent unauthorized persons who may obtain access to the physical data processing system to obtain any data from the data processing system. Enterprise Data Access unit 702 establishes and maintains communication links with a central server or other data processing system within the enterprise's network and transmits and receives data through this communication link. Enterprise Data Access unit 702, when a network connection is unavailable, may check for network availability while the user performs normal activities and, when the network becomes available, connects the network and transmits data without the need for user involvement. Device management unit 718 manages computer resources and updates software or data on the data processing system as updates or data is received from a central server. Device management 718 also handles backup and restore of user data; device configuration; and hardware and software inventory. Security unit 720 provides security, such as, disabling data processing system components, when a valid user id and password have not been provided, as well as ensuring that security policies have been adhered to prior to transmitting information to a central server. Security unit 720 may also provide automatic timeouts wherein data input and output from the data processing system is disabled if the device has been inactive for too long a period of time, thereby preventing unauthorized access to data on the device. Once a user re-authenticates themselves to the agent, the user may then be taken back to where they were before the timeout occurred. Security unit 720 works in conjunction with encryption unit 708 to encrypt data on the device to prevent unauthorized access to data on the device as well as encrypting data prior to transmission across a network or for implementation of a Virtual Private Network (VPN).

Application 700 is provided as an example of an application for providing a GUI and automatic background computer maintenance, security, and communication functions and is not meant to imply any architectural limitations to the present invention. Those skilled in the art will recognize that application 700 may be modified in many ways without departing from the scope or spirit of the present invention.

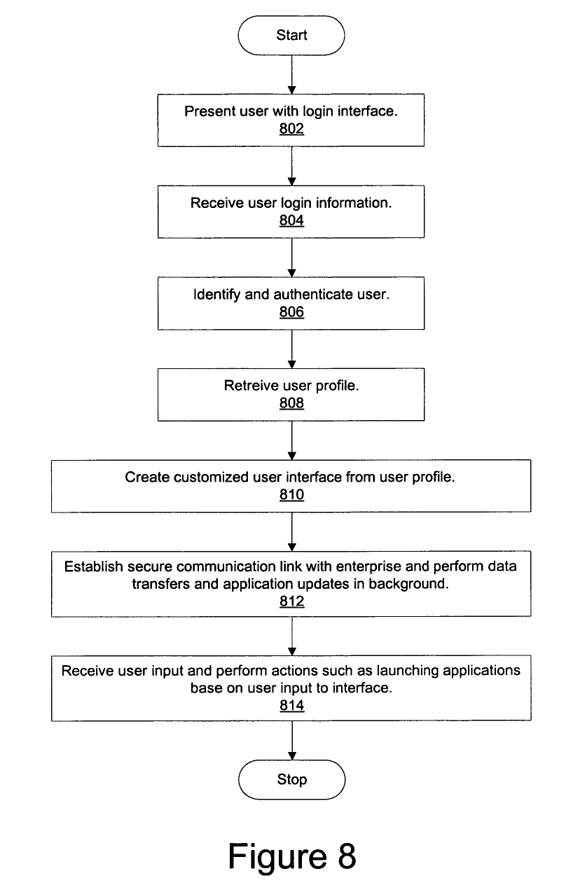

With reference now to FIG. 8, a diagram illustrating an exemplary program function and process flow for providing a customized Graphical User Interface (GUI) and automatic computer maintenance functions is depicted in accordance with one embodiment of the present invention. To being, the user is presented with a login interface (step 802) allowing the user to provide a user id and password. The term “Agent” is used to describe software executing on the user's computer which manages the GUI. The user login information is received by the Agent (step 804) and the user is identified and authenticated (step 806). Typically, the user login information is merely a user name and password. Once the user has been identified and authenticated, the user's profile is retrieved (step 808). The user profile determines the type of interface to present to the user and is customized to include those applications, data, and other resources that are crucial for the user to perform his work duties. Other applications and data that are needed only for maintaining the proper function of the computer, updating applications, implementing communication and security protocols are not provided in the user interface, thus avoid confusing the user with extraneous information and thereby facilitating work efficiency by the user. If human interaction is needed in order to perform maintenance on the computer, a separate user profile for a system administrator may be created which provides the system administrator with a user interface allowing access to all features of the data processing system.

Furthermore, once the user has logged onto the system, the system may then login to a remote server or other remote system by providing user names and passwords to the server as necessary to login to the server without requiring the user to enter any further information. All other user names, passwords or other security features are maintained and executed by the agent as necessary based on the user profile determined from the user identity.

Once the user profile has been retrieved, a customized user interface is presented based on the user profile (step 810). The Agent may then establish a secure communication link with an enterprise and perform data transfers and application updates automatically in the background as needed without need of user interaction. This secure communication link may require that user credentials such as user ID and password be passed to other places. However, once the user has authenticated his or herself to the agent by entering his or her user ID and password to the agent, the agent then performs any remaining authentication procedures. These processes are transparent to the user. Furthermore, the data processing system may receive pull requests from the central server requesting certain data and information which the Agent automatically locates and sends to the central server without the necessity of user interaction. The Agent may also receive data or application updates from the central server and perform the actions necessary to update the data processing system, again without the necessity of human interaction. The Agent also receives user input and performs actions, such as, for example, launching applications and logging usage information, based on user input to the interface (step 814).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing a customized user interface and automatically providing maintenance, security, and communications functions for a data processing system requiring little user input, the method comprising:
receiving user login information;
retrieving a user profile; and
providing a customized user interface based on the user profile wherein only applications and information needed by the user to perform an enterprise defined function are presented to the user.

2. The method as recited in claim 1, further comprising:
securely establishing a communication link with a network data processing system.

3. The method as recited in claim 2, further comprising:
receiving data from the network data processing system.

4. The method as recited in claim 3, wherein the data is an update and further comprising:
performing actions necessary to update the data processing system without involving a user in an update process.

5. The method as recited in claim 3, wherein the data is a request for requested data from the data processing system and further comprising:
retrieving the requested data; and
transmitting the requested data to the network data processing system.

6. The method as recited in claim 1, wherein the customized user interface comprises an application area presenting indications of applications that are available to the user wherein the indications are selectable by the user in order to launch a respective application.

7. The method as recited in claim 1, wherein the customized user interface comprises a data area providing access to data related to the user's job functions.

8. The method as recited in claim 1, further comprising:
implementing an a rules based capability that implements enterprise security policy.

9. The method as recited in claim 8, wherein the security policy comprises at least one of encrypting data prior to transmitting the data, encrypting data within the data processing system when the data processing system is at rest, displaying an indication as to whether a network connection is active, and locking down the data processing system to prevent access whenever the data processing system has been idle for longer than a predefined time period.

10. A computer program product in a computer readable media for use in a data processing system for providing a customized user interface and automatically providing maintenance, security, and communications functions for a data processing system requiring little user input, the computer program product comprising:
first instructions for receiving user login information;
second instructions for retrieving a user profile; and
third instructions for providing a customized user interface based on the user profile wherein only applications and information needed by the user to perform an enterprise defined function are presented to the user.

11. The computer program product as recited in claim 10, further comprising:
fourth instructions for securely establishing a communication link with a network data processing system.

12. The computer program product as recited in claim 11, further comprising:
fifth instructions for receiving data from the network data processing system.

13. The computer program product as recited in claim 12, wherein the data is an update and further comprising:
fifth instructions for performing actions necessary to update the data processing system without involving a user in an update process.

14. The computer program product as recited in claim 12, wherein the data is a request for requested data from the data processing system and further comprising:
fifth instructions for retrieving the requested data; and
sixth instructions for transmitting the requested data to the network data processing system.

15. The computer program product as recited in claim 10, wherein the customized user interface comprises an application area presenting indications of applications that are available to the user wherein the indications are selectable by the user in order to launch a respective application.

16. The computer program product as recited in claim 10, wherein the customized user interface comprises a data area providing access to data related to the user's job functions.

17. The computer program product as recited in claim 10, further comprising:
fourth instructions for implementing an a rules based capability that implements enterprise security policy.

18. The computer program product as recited in claim 17, wherein the security policy comprises at least one of encrypting data prior to transmitting the data, encrypting data within the data processing system when the data processing system is at rest, displaying an indication as to whether a network connection is active, and locking down the data processing system to prevent access whenever the data processing system has been idle for longer than a predefined time period.

19. A system for providing a customized user interface and automatically providing maintenance, security, and communications functions for a data processing system requiring little user input, the system comprising:
first means for receiving user login information;
second means for retrieving a user profile; and
third means for providing a customized user interface based on the user profile wherein only applications and information needed by the user to perform an enterprise defined function are presented to the user.

20. The system as recited in claim 19, further comprising:
fourth means for securely establishing a communication link with a network data processing system.

21. The system as recited in claim 20, further comprising:
fifth means for receiving data from the network data processing system.

22. The system as recited in claim 21, wherein the data is an update and further comprising:
fifth means for performing actions necessary to update the data processing system without involving a user in an update process.

23. The system as recited in claim 21, wherein the data is a request for requested data from the data processing system and further comprising:
fifth means for retrieving the requested data; and
sixth means for transmitting the requested data to the network data processing system.

24. The system as recited in claim 19, wherein the customized user interface comprises an application area presenting indications of applications that are available to the user wherein the indications are selectable by the user in order to launch a respective application.

25. The system as recited in claim 19, wherein the customized user interface comprises a data area providing access to data related to the user's job functions.

26. The system as recited in claim 19, further comprising:
fourth means for implementing an a rules based capability that implements enterprise security policy.

27. The system as recited in claim 26, wherein the security policy comprises at least one of encrypting data prior to transmitting the data, encrypting data within the data processing system when the data processing system is at rest, displaying an indication as to whether a network connection is active, and locking down the data processing system to prevent access whenever the data processing system has been idle for longer than a predefined time period.
